(19) United States
(12) Patent Application Publication
(10) Pub. No.: US 2025/0078859 A1
(43) Pub. Date: Mar. 6, 2025

(54) SOURCE SEPARATION BASED SPEECH ENHANCEMENT

(71) Applicant: BOSE CORPORATION, Framingham, MA (US)

(72) Inventors: Shuo ZHANG, Belmont, MA (US); Marko STAMENOVIC, Truro, MA (US); Li-Chia YANG, Chelmsford, MA (US); Alexander D. PAWLICKI, Newbury, MA (US); Patrick BUZZA, Somerville, MA (US); Yang LIU, Boston, MA (US); Mark BLEWETT, Framingham, MA (US); Eric FREEMAN, Sutton, MA (US); Sile YIN, Atlanta, GA (US)

(21) Appl. No.: 18/457,891

(22) Filed: Aug. 29, 2023

(51) Int. Cl. G10L 21/0364; G10L 21/028; G10L 21/034

(52) U.S. Cl. CPC G10L 21/0364; G10L 21/028; G10L 21/034

(57) ABSTRACT

Aspects of the present disclosure provide techniques, including devices and systems implementing the techniques, for audio signal processing in a device. In some aspects, the audio signal processing may involve providing source separation based speech enhancement in a device. One example technique for providing source separation based speech enhancement generally includes receiving, at the device, an input audio signal, extracting a speech component from the input audio signal, modifying the speech component to generate a modified speech component, and mixing the modified speech component with at least a portion of the input audio signal to generate a synchronized playback audio signal. Providing source separation based speech enhancement may allow for a user consuming the playback audio to be able to fully enjoy any speech component in the playback audio without excessive and undesirable interference from other portions of the playback audio (e.g., background noise or music) overpowering the speech component.

### FIELD

Aspects of the disclosure generally relate to audio signal processing.

### BACKGROUND

Audio devices are often utilized to enjoy various forms of entertainment. For example, audio devices may be used to enjoy movies, television, sports, games, and other similar entertainment. In these cases, the audio devices may be used to deliver audio to users during consumption of entertainment. Frequently, the audio used in entertainment may include several different parts, including speech (e.g., dialog), music, action noises, and other audio parts. At times, it may be challenging for audio devices to consistently provide clear and intelligible speech to users due to the presence of the non-speech component in the audio that may sometimes be overpowering and cause undesirable interference to the speech component.

Accordingly, methods for providing speech enhancement, as well as apparatuses and systems configured to implement these methods, are desired.

### SUMMARY

All examples and features mentioned herein can be combined in any technically possible manner.

Aspects of the present disclosure provide a method for audio signal processing in a device. The method includes receiving, at the device, an input audio signal, extracting a speech component from the input audio signal, modifying the speech component to generate a modified speech component, and mixing the modified speech component with at least a portion of the input audio signal to generate a synchronized playback audio signal.

In aspects, the extracting is performed using a trained machine-learning model.

In aspects, the trained machine-learning model includes at least one memory cache configured to store data associated with the extracting.

In aspects, the trained machine-learning model includes a deep learning model configured to predict a filter, the filter being configured to extract the speech component from the input audio signal.

In aspects, modifying the speech component to generate the modified speech component includes: applying a gain to the speech component.

In aspects, the gain is based on at least one of: a user input, or a user profile.

In aspects, the gain includes a fixed gain.

In aspects, the gain includes a dynamic gain associated with a desired signal-to-noise ratio (SNR) of the synchronized playback audio signal.

In aspects, the desired SNR of the synchronized playback audio signal is based, at least in part, on a model of an intelligibility of the speech component given the input audio signal.

In aspects, the mixing is based, at least in part, on at least one of a recommendation, a specification, or legislation for an environment that the device is located in.

In aspects, the speech component includes at least a first portion of the speech component and a second portion of the speech component, where modifying the speech component to generate the modified speech component includes applying a first gain to the first portion of the speech component and a second gain to the second portion of the speech component, and where the first gain is different than the second gain.

In aspects, the device includes a wearable audio device.

Aspects of the present disclosure provide a system. The system includes a device, and one or more processors coupled to the device. The one or more processors are configured to: receive, at the device, an input audio signal, extract a speech component from the input audio signal, modify the speech component to generate a modified speech component, and mix the modified speech component with at least a portion of the input audio signal to generate a synchronized playback audio signal.

In aspects, the one or more processors are configured to modify the speech component to generate the modified speech component by applying a gain to the speech component.

In aspects, the gain includes a fixed gain.

In aspects, the gain includes a dynamic gain associated with a desired SNR of the synchronized playback audio signal.

Aspects of the present disclosure provide a non-transitory computer-readable medium including computer-executable instructions that, when executed by one or more processors of a device, cause the device to perform a method for audio signal processing. The method includes receiving, at the device, an input audio signal, extracting a speech component from the input audio signal, modifying the speech component to generate a modified speech component, and mixing the modified speech component with at least a portion of the input audio signal to generate a synchronized playback audio signal.

In aspects, modifying the speech component to generate the modified speech component includes: applying a gain to the speech component.

In aspects, the gain includes a fixed gain.

In aspects, the gain includes a dynamic gain associated with a desired SNR of the synchronized playback audio signal.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates another example system, in which aspects of the present disclosure may be implemented.

FIG. 3A illustrates an exemplary sound processing and playback device, in which aspects of the present disclosure may be implemented.

FIG. 3B illustrates an exemplary source device, in which aspects of the present disclosure may be implemented.

FIG. 4 illustrates a block diagram of a machine learning network and related components, in accordance with certain aspects of the present disclosure.

FIG. 5 is a flow diagram illustrating example operations for speech enhancement, in accordance with certain aspects of the present disclosure.

FIG. 6 illustrates an example input audio signal during the operations of FIG. 6, in accordance with certain aspects of the present disclosure.

Like numerals indicate like elements, and “speech” and “dialogue” may be used interchangeably.

### DETAILED DESCRIPTION

Certain aspects of the present disclosure provide techniques, including devices and systems implementing the techniques, for providing source separation based speech enhancement. Providing source separation based speech enhancement may involve extracting a speech component from an input audio stream, enhancing the extracted speech component, and mixing the enhanced speech component with at least a portion of the input audio stream to generate synchronized playback audio which includes the enhanced speech component. By utilizing the synchronized playback audio with the enhanced speech component, a device (e.g., a sound bar, speaker, a wearable audio device, or the like) may ensure that a user is able to fully enjoy any speech component in the playback audio without excessive and undesirable interference from other portions of the playback audio (e.g., background music, action noises, and other audio parts) that may overpower the speech component.

Many users utilize audio devices to enjoy various forms of entertainment. For example, users may use audio devices (e.g., a sound bar, speaker, a wearable audio device, or the like) to enjoy movies, television shows, sports, games, music, podcasts, and other similar entertainment. In these cases, the audio devices may be used to deliver audio to users during consumption of entertainment. Often, the audio used in entertainment may include several parts. For example, audio may include speech, music, action noise, and/or other audio. At times, it may be challenging for audio devices to consistently provide clear and intelligible speech to users, due to other components of the audio used in the entertainment that may sometimes be overpowering and cause undesirable interference to the speech component.

Audio devices may employ a dialog mode to attempt to provide clear and intelligible speech to users. Dialog mode may involve applying an equalization (EQ) to the audio (e.g., the input audio stream) of an audio device. A user may turn on dialog mode for an audio device, or dialog mode may even be intelligently started by the audio device when the device detects speech. In this manner, the audio device may apply the EQ universally to the entirety of the audio (both the speech and non-speech) to enhance the speech component. When an EQ is applied to the full audio, both the speech component of the audio (e.g., the dialog), as well as the non-speech component of the dialog (e.g., background noise, music), are affected. In other words, boosting the speech component of the audio in a center channel of an audio device may also boost the non-speech component of the audio. While the speech component may be more clear and intelligible as a result of the boost, the non-speech component may suffer. For example, the music, background noise, and/or other sound effects of an input audio stream may be modified along with the speech, which may result in less powerful, less expansive, and less spacious sound, and/or decreased precision. In addition, modifying the music, background noise, or other sound effects along with the speech may cause the resultant playback audio outputted from the device to greatly deviate from the audio experience that was desired by the author(s) and/or providers of the entertainment. Furthermore, a user may have to remember to activate and deactivate the dialog mode on an audio device, or the audio device may have to properly ascertain whether to activate and deactivate the dialog mode based on imperfect algorithms. As a result, the application of the dialog mode may be flawed, and may not be consistently and accurately applied to the audio entertainment.

The present disclosure may enable an audio device to perform speech enhancement on an input audio stream without user intervention and without negatively impacting the non-speech component of the input audio stream. As a result, users may be able to fully enjoy playback audio from an audio device (both the speech component and non-speech component), without excessive and undesirable interference to the speech component from the non-speech portions of the playback audio, and without negative impacts on the non-speech component that result from a universally applied speech enhancement.

### An Example System

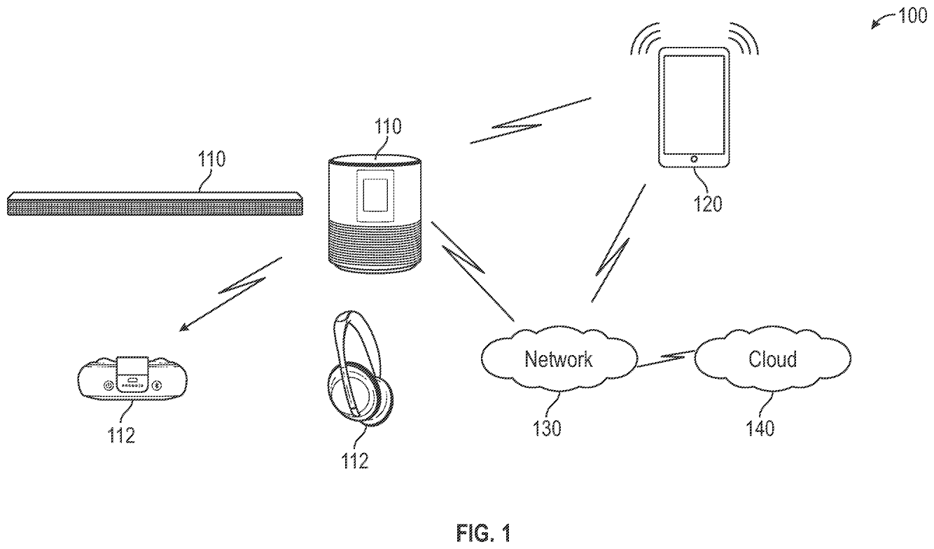

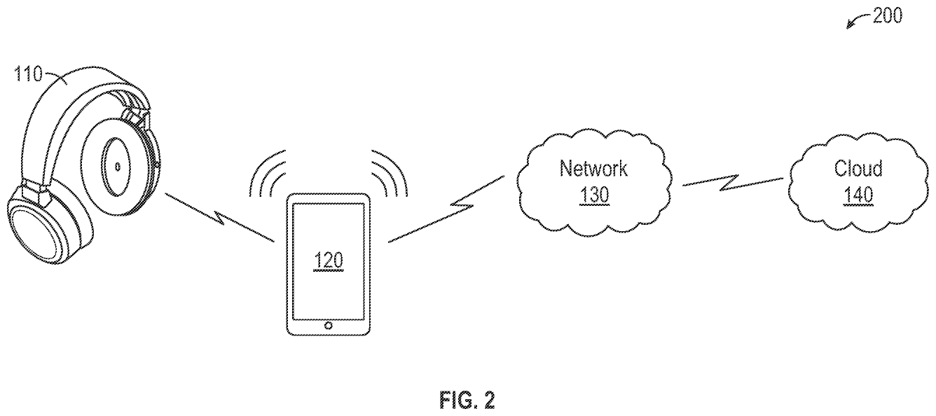

FIG. 1 illustrates an example system 100, in which aspects of the present disclosure may be implemented. As shown, system 100 includes one or more sound processing and playback devices 110 (e.g., a wireless audio device, such as a sound bar or a smart speaker; or a wearable device, as shown in FIG. 2) communicatively coupled with a source device 120 (e.g., a computing device or user device, such as a smartphone, tablet computer, television, or the like). Throughout the present disclosure, the sound processing and playback device 110 may be referred to simply as the device 110. In the example of FIG. 1, the device 110 is shown implemented as both a sound bar and a smart speaker. One or more partner devices 112 (e.g., a portable speaker, a headset, or the like) may be available to accept pairing requests from the device 110 or the source device 120. The device 110 may be paired with the source device 120 and may receive content data (including audio signal(s)) from the source device 120. The device 110 may also receive content data directly from the network 130. The partner device 112 may be battery-powered portable devices suitable for mobile or privacy applications.

According to aspects of the present disclosure, the device 110 may receive an original set of audio signals (e.g., input audio stream) from at least one of the source device 120, the network 130, or the cloud 140 (via the network 130). The device 110 may identify and extract the speech component (if any) of the original audio signals. The identification and the extraction of the speech component may be performed by various techniques, such as using a trained machine-learning model and as described herein. The device 110 may modify the speech component to generate a modified (e.g., enhanced) speech component. The device 110 may mix the modified speech component with at least part of the original audio signals to generate a synchronized playback audio signal. The device 110 may output the synchronized playback audio signal.

The device 110 may include hardware and circuitry including processor(s)/processing system and memory configured to implement one or more sound management capabilities or other capabilities including, but not limited to, noise cancelling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the device 110 by using active noise cancelling (also known as active noise reduction). The sound masking circuitry is configured to reduce distractions by playing masking sounds via the speakers of the device 110. The movement detecting circuitry is configured to use devices/sensors such as an accelerometer, gyroscope, magnetometer, or the like to detect whether the user wearing the device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In some aspects, the device 110 may be wirelessly connected to the source device 120 or the partner devices 112 using one or more wireless communication methods including, but not limited to, Bluetooth, Wi-Fi, Bluetooth Low Energy (BLE), other radio frequency (RF) based techniques, or the like. In an aspect, the device 110 includes a transceiver that transmits and receives data via one or more antennae in order to exchange audio data and other information with the source device 120.

In some aspects, the device 110 includes communication circuitry capable of transmitting and receiving audio data and other information from the source device 120. The device 110 also includes an incoming audio buffer, such as a render buffer, that buffers at least a portion of an incoming audio signal (e.g., audio packets) in order to allow time for retransmissions of any missed or dropped data packets from the source device 120. For example, when the device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the device 110. This is done to ensure that even if there are RF collisions that cause audio packets to be lost during transmission, that there is time for the lost audio packets to be retransmitted by the source device 120 before they have to be rendered by the device 110 for output by one or more acoustic transducers of the device 110.

One example of the partner device 112 is shown as noise-canceling headphones; however, the techniques described herein apply to other wireless audio devices, such as wearable audio devices, including any audio output device that fits around, on, in, or near an ear (including open-ear audio devices worn on the head or shoulders of a user) or other body parts of a user, such as head or neck. The partner device 112 may take any form, wearable or otherwise, including standalone alone devices (including automobile speaker system), stationary devices (including portable devices, such as battery powered portable speakers), headphones, earphones, earpieces, headsets, goggles, headbands, earbuds, armbands, sport headphones, neckband, or eyeglasses with integrated speaker(s).

In some aspects, the device 110 is connected to the source device 120 using a wired connection, with or without a corresponding wireless connection. The source device 120 can be a smartphone, a tablet computer, a laptop computer, a digital camera, or other user device that connects with the device 110. As shown, the source device 120 can be connected to a network 130 (e.g., the Internet) and can access one or more services over the network. As shown, these services can include one or more cloud services 140.

In some aspects, the source device 120 can access a cloud server in the cloud 140 over the network 130 using a mobile web browser or a local software application or “app” executed on the source device 120. In some aspects, the software application or “app” is a local application that is installed and runs locally on the source device 120. In some aspects, a cloud server accessible on the cloud 140 includes one or more cloud applications that are run on the cloud server. The cloud application can be accessed and run by the source device 120. For example, the cloud application can generate web pages that are rendered by the mobile web browser on the source device 120. In an aspect, a mobile software application installed on the source device 120 or a cloud application installed on a cloud server, individually or in combination, may be used to implement the techniques for low latency Bluetooth communication between the source device 120 and the device 110 in accordance with aspects of the present disclosure. In some aspects, examples of the local software application and the cloud application include a gaming application, an audio AR application, and/or a gaming application with audio AR capabilities. The source device 120 may receive signals (e.g., data and controls) from the device 110 and send signals to the device 110.

FIG. 2 illustrates another example system 200, in which aspects of the present disclosure may be implemented. In the example of FIG. 2, the sound processing and playback device 110 is shown implemented as a wearable device configured to be worn by a user, and may be a headset that includes two or more speakers, as illustrated in FIG. 2. At a high level, the device 110 may play audio content transmitted from the source device 120. The user may use the graphical user interface (GUI) on the source device 120 to select the audio content and/or adjust settings of the device 110. The device 110 provides soundproofing, active noise cancellation, and/or other audio enhancement features to play the audio content transmitted from the source device 120.

The device 110 is illustrated in FIG. 2 as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, or eyeglasses.

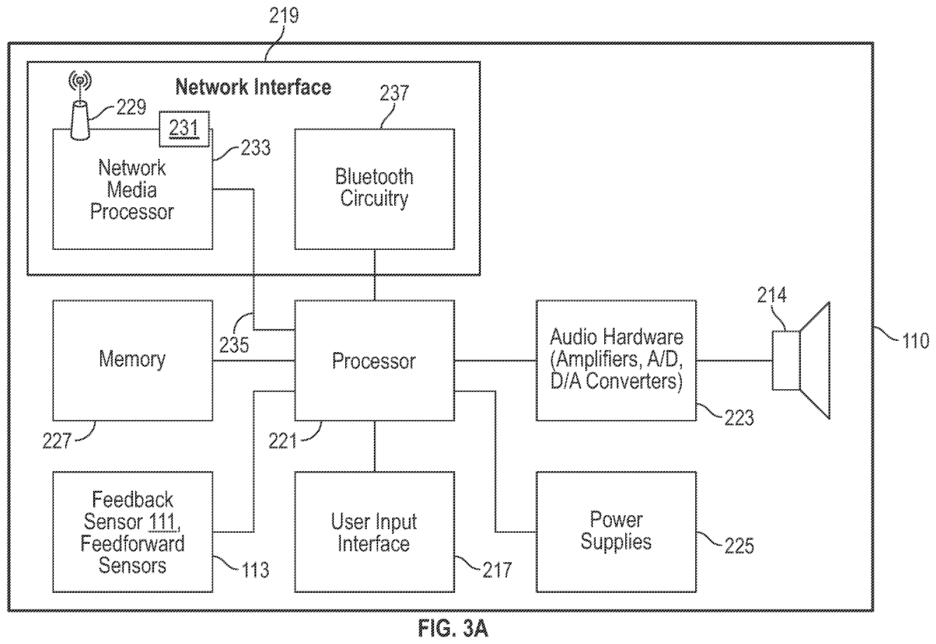

FIG. 3A illustrates an exemplary device 110 and some of its components. Other components may be inherent in the device 110 and not shown in FIG. 3A. For example, the device 110 may include an enclosure that houses an optional graphical interface (e.g., an organic light-emitting diode (OLED) display) which can provide the user with information regarding currently playing (“Now Playing”) music. In some aspects, the partner device 112 may include components illustrated in FIG. 3A and described above.

The device 110 may include one or more electro-acoustic transducers (or speakers) 214 for outputting audio. The device 110 may also include a user input interface 217. The user input interface 217 may include a plurality of preset indicators, which may be hardware buttons. The preset indicators may provide the user with easy, one press access to entities assigned to those buttons. The assigned entities may be associated with different ones of the digital audio sources such that a single device 110 may provide for single press access to various different digital audio sources.

The device 110 may include a feedback sensor 111 and feedforward sensors 113. The feedback sensor 111 and feedforward sensors 113 may include two or more microphones for capturing ambient sound and provide audio signals for determining location attributes of events. The transmission delays may be used to reduce errors in subsequent computation. The feedforward sensors 113 may provide two or more channels of audio signals. The audio signals are captured by microphones that are spaced apart and may have different directional responses. The two or more channels of audio signals may be used for calculating directional attributes of an event of interest.

As shown in FIG. 3A, the device 110 may include an acoustic driver or speaker 214 to transduce audio signals to acoustic energy through audio hardware 223. The device 110 also may include a network interface 219, at least one processor 221, the audio hardware 223, power supplies 225 for powering the various components of the device 110, and memory 227. In certain aspects, the processor 221, the network interface 219, the audio hardware 223, the power supplies 225, and the memory 227 are interconnected using various buses 235, and several of the components can be mounted on a common motherboard or in other manners as appropriate.

The network interface 219 provides for communication between the device 110 and other electronic computing devices via one or more communications protocols, such as Bluetooth classic protocol, Bluetooth low energy protocol, and others. The network interface 219 provides either or both of a wireless network interface 229 and a wired interface 231. The wireless interface 229 allows the device 110 to communicate wirelessly with other devices in accordance with a wireless communication protocol such as IEEE 802.11. The wired interface 231 provides network interface functions via a wired (e.g., Ethernet) connection for reliability and fast transfer rate, for example, used when the device 110 is not worn by a user. Although illustrated, the wired interface 231 is optional.

In certain aspects, the network interface 219 includes a network media processor 233 for supporting Apple AirPlay® and/or Apple Airplay© 2. For example, if a user connects an AirPlay® or Apple Airplay® 2 enabled device, such as an iPhone or iPad device, to the network, the user can then stream music to the network connected audio playback devices via Apple AirPlay® or Apple Airplay® 2. Notably, the audio playback device can support audio-streaming via AirPlay®, Apple Airplay® 2 and/or Digital Living Network Alliance's (DLNA) Universal Plug and Play (UPnP) protocols, all integrated within one device.

All other digital audio received as part of network packets may pass straight from the network media processor 233 through a universal serial bus (USB) bridge (not shown) to the processor 221 and runs into the decoders, DSP, and eventually is played back (rendered) via the electro-acoustic transducer(s) 214.

The network interface 219 can further include Bluetooth circuitry 237 for Bluetooth applications (e.g., for wireless communication with a Bluetooth enabled audio source such as a smartphone or tablet) or other Bluetooth enabled speaker packages. In some aspects, the Bluetooth circuitry 237 may be the primary network interface 219 due to energy constraints. For example, the network interface 219 may use the Bluetooth circuitry 237 solely for mobile applications when the wearable device 210 adopts any wearable form. For example, BLE technologies may be used in the wearable device 210 to extend battery life, reduce package weight, and provide high quality performance without other backup or alternative network interfaces.

In certain aspects, the network interface 219 supports communication with other devices using multiple communication protocols simultaneously at one time. For instance, the device 110 can support Wi-Fi/Bluetooth coexistence and can support simultaneous communication using both Wi-Fi and Bluetooth protocols at one time. For example, the device 110 can receive an audio stream from a smart phone using Bluetooth and can further simultaneously redistribute the audio stream to one or more other devices over Wi-Fi. In certain aspects, the network interface 219 may include only one RF chain capable of communicating using only one communication method (e.g., Wi-Fi or Bluetooth) at one time. In this context, the network interface 219 may simultaneously support Wi-Fi and Bluetooth communications by time sharing the single RF chain between Wi-Fi and Bluetooth, for example, according to a time division multiplexing (TDM) pattern.

Streamed data may pass from the network interface 219 to the processor 221. The processor 221 may execute instructions (e.g., for performing, among other things, digital signal processing, decoding, and equalization functions), including instructions stored in the memory 227. The processor 221 may be implemented as a chipset of chips that includes separate and multiple analog and digital processors. The processor 221 may provide, for example, for coordination of other components of the device 110, such as control of user interfaces.

The memory 227 may store software/firmware related to protocols and versions thereof used by the device 110 for communicating with other networked devices, including the source device 120. For example, the software/firmware governs how the device 110 communicates with other devices for synchronized playback of audio. In some aspects, the software/firmware includes lower level frame protocols related to control path management and audio path management. The protocols related to control path management generally include protocols used for exchanging messages between speakers. The protocols related to audio path management generally include protocols used for clock synchronization, audio distribution/frame synchronization, audio decoder/time alignment, and playback of an audio stream. In some aspects, the memory can also store various codecs supported by the speaker package for audio playback of respective media formats. In some aspects, the software/firmware stored in the memory can be accessible and executable by the processor for synchronized playback of audio with other networked speaker packages.

In certain aspects, the protocols stored in the memory 227 may include BLE according to, for example, the Bluetooth Core Specification Version 5.2 (BT5.2). The device 110 and the various components therein are provided herein to sufficiently comply with or perform aspects of the protocols and the associated specifications. For example, BT5.2 includes enhanced attribute protocol (EATT) that supports concurrent transactions. A new L2CAP mode is defined to support EATT. As such, the device 110 may include hardware and software components sufficiently to support the specifications and modes of operations of BT5.2, even if not expressly illustrated or discussed in this disclosure. For example, the device 110 may utilize LE Isochronous Channels specified in BT5.2.

The processor 221 provides a processed digital audio signal to the audio hardware 223 which includes one or more digital-to-analog (D/A) converters for converting the digital audio signal to an analog audio signal. The audio hardware 223 also includes one or more amplifiers which provide amplified analog audio signals to the electro-acoustic transducer(s) 214 for sound output. In addition, the audio hardware 223 may include circuitry for processing analog input signals to provide digital audio signals for sharing with other devices, for example, other speaker packages for synchronized output of the digital audio.

The memory 227 can include, for example, flash memory and/or non-volatile random-access memory (NVRAM). In some aspects, instructions (e.g., software) are stored in an information carrier. The instructions, when executed by one or more processing devices (e.g., the processor 221), perform one or more processes, such as those described elsewhere herein. The instructions can also be stored by one or more storage devices, such as one or more computer or machine-readable mediums (for example, the memory 227, or memory on the processor). The instructions can include instructions for performing decoding (i.e., the software modules include the audio codecs for decoding the digital audio streams), as well as digital signal processing and equalization. In certain aspects, the memory 227 and the processor 221 may collaborate in data acquisition and real time processing with the feedback microphone 111 and feedforward microphones 113.

FIG. 3B illustrates an exemplary source device 120, such as a smartphone or a mobile computing device, in accordance with certain aspects of the present disclosure. Some components of the source device 120 may be inherent and not shown in FIG. 3B. For example, the source device 120 may include an enclosure. The enclosure may house an optional graphical interface 212 (e.g., an OLED display), as shown. The graphical interface 212 provides the user with information regarding currently playing (“Now Playing”) music or video. The source device 120 includes one or more electro-acoustic transducers 215 for outputting audio. The source device 120 may also include a user input interface 216 that enables user input.

The source device 120 also includes a network interface 220, at least one processor 222, audio hardware 224, power supplies 226 for powering the various components of the source device 120, and a memory 228. In certain aspects, the processor 222, the graphical interface 212, the network interface 220, the audio hardware 224, the one or more power supplies 226, and the memory 228 are interconnected using various buses 236, and several of the components can be mounted on a common motherboard or in other manners as appropriate. In some aspects, the processor 222 of the source device 120 is more powerful in terms of computation capacity than the processor 221 of the device 110. Such difference may be due to constraints of weight, power supplies, and other requirements. Similarly, the power supplies 226 of the source device 120 may be of a greater capacity and heavier than the power supplies 225 of the device 110.

The network interface 220 provides for communication between the source device 120 and the device 110, as well as other audio sources and other wireless speaker packages including one or more networked wireless speaker packages and other audio playback devices via one or more communications protocols. The network interface 220 can provide either or both of a wireless interface 230 and a wired interface 232. The wireless interface 230 allows the source device 120 to communicate wirelessly with other devices in accordance with a wireless communication protocol, such as IEEE 802.11. The wired interface 232 provides network interface functions via a wired (e.g., Ethernet) connection.

In certain aspects, the network interface 220 may also include a network media processor 234 and Bluetooth circuitry 238, similar to the network media processor 233 and Bluetooth circuitry 237 in the device 110 in FIG. 3A. Further, in aspects, the network interface 220 supports communication with other devices using multiple communication protocols simultaneously at one time, as described with respect to the network interface 219 in FIG. 3A.

All other digital audio received as part of network packets comes straight from the network media processor 234 through a bus 236 (e.g., USB bridge) to the processor 222 and runs into the decoders, DSP, and eventually is played back (rendered) via the electro-acoustic transducer(s) 215.

The source device 120 may also include an image or video acquisition unit 280 for capturing image or video data. For example, the image or video acquisition unit 280 may be connected to one or more cameras 282 and capable of capturing still or motion images. The image or video acquisition unit 280 may operate at various resolutions or frame rates according to a user selection. For example, the image or video acquisition unit 280 may capture 4K videos (e.g., a resolution of 3840 by 2160 pixels) with the one or more cameras 282 at 30 frames per second, full high definition (FHD) videos (e.g., a resolution of 1920 by 1080 pixels) at 60 frames per second, or a slow motion video at a lower resolution, depending on hardware capabilities of the one or more cameras 282 and the user input. The one or more cameras 282 may include two or more individual camera units having respective lenses of different properties, such as focal length resulting in different fields of views. The image or video acquisition unit 280 may switch between the two or more individual camera units of the cameras 282 during a continuous recording.

Captured audio or audio recordings, such as the voice recording captured at the device 110, may pass from the network interface 220 to the processor 222. The processor 222 executes instructions within the wireless speaker package (e.g., for performing, among other things, digital signal processing, decoding, and equalization functions), including instructions stored in the memory 228. The processor 222 can be implemented as a chipset of chips that includes separate and multiple analog and digital processors. The processor 222 can provide, for example, for coordination of other components of the audio source device 120, such as control of user interfaces and applications. The processor 222 provides a processed digital audio signal to the audio hardware 224 similar to the respective operation by the processor 221 described in FIG. 3A.

The memory 228 can include, for example, flash memory and/or NVRAM. In certain aspects, instructions (e.g., software) are stored in an information carrier. The instructions, when executed by one or more processing devices (e.g., the processor 222), perform one or more processes, such as those described herein. The instructions can also be stored by one or more storage devices, such as one or more computer or machine-readable mediums (for example, the memory 228, or memory on the processor 222). The instructions can include instructions for performing decoding (i.e., the software modules include the audio codecs for decoding the digital audio streams), as well as digital signal processing and equalization.

### Example Speech Enhancement

Aspects of the present disclosure provide techniques for providing source separation based speech enhancement. During source separation based speech enhancement, an audio device may identify, in an original set of audio signals, a speech component (if any) using any number of methods. For example, a trained machine-learning network versed in mixed categories of audio content may be used to identify a speech component in an original set of audios. The speech component includes sound elements that carry linguistic meanings. The audio device may then modify the identified speech component in a number of ways (e.g., by applying a gain to the speech component). In order to correctly detect and extract the speech component (e.g., as opposed to, for example, a singing component), the machine-learning network may be trained to recognize what constitutes speech.

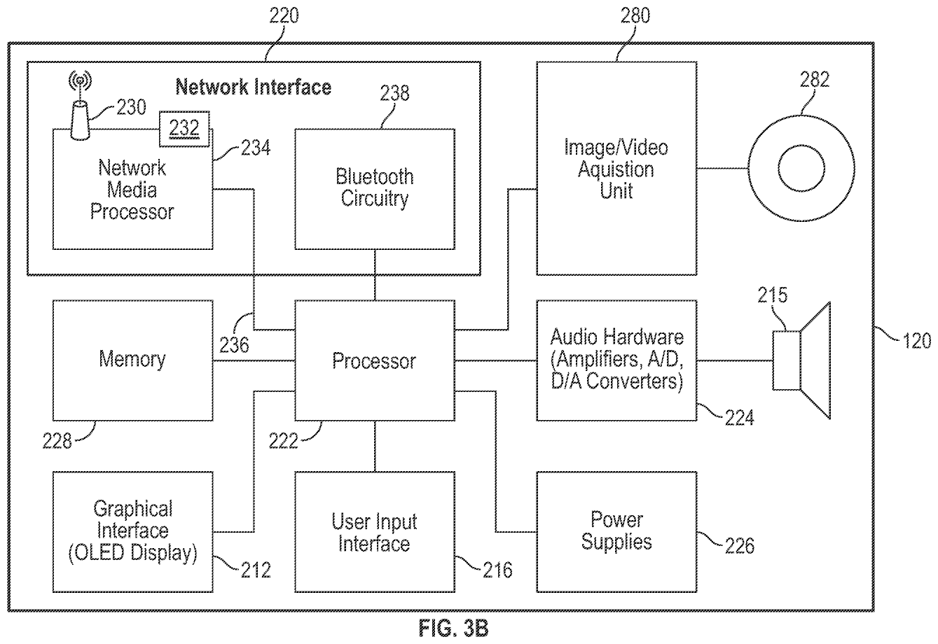

FIG. 4 is a block diagram 400 illustrating relationships between audio signals, training data set, and processing components, in accordance with aspects of the present disclosure. As shown, the original set of audio signals 410 (e.g., input audio stream), such as received by the device 110, is provided to the speech component extraction module 420. In some cases, the device 110 may be communicatively coupled with the speech component extraction module 420 via the network 130.

The speech component extraction module 420 may include or be implemented by a machine-learning network (not illustrated). The speech component extraction module 420 may be configured to analyze the original set of audio signals 410 and identify the speech component 430 (e.g., using a machine-learning network). In some cases, the speech component extraction module 420 may use a machine-learning model 425. In some cases, the machine-learning model 425 may be implemented by a deep learning model. In certain aspects, a plurality of machine-learning models 425 may be used by the speech component extraction module 420. In some cases, the speech component extraction module 420 or its interface (e.g., a graphical user interface, such as an application on an operating system) may be installed on the source device 120, which may be a smartphone.

The machine-learning model 425 may use various machine learning techniques based on artificial neural networks. For example, the machine-learning model 425, when implemented as a deep learning model, may include deep learning architectures, such as deep neural networks, deep belief networks, deep reinforcement learning, recurrent neural networks, convolutional neural networks, and the like. Similar to speech recognition, the machine-learning model 425 may identify sound elements that include linguistic meanings. On the other hand, the machine-learning model 425 may be trained to distinguish sound elements that primarily express linguistic meanings versus sound elements that primarily express tonal or musical elements other than linguistic meanings in contexts.

For example, the machine-learning model 425 may be trained to distinguish a speech component from a music component or a singing component. The speech component 430 may include sounds in which meanings are conveyed based on linguistic characteristics. The music component (not illustrated) may include sounds that lack linguistic characteristics. The singing component may include a mixture of sounds that simultaneously includes a component of linguistic expressions and a component of musical expressions.

The machine-learning model 425 may be trained, based on the training data set 460, to identify sounds that do not include musical expressions or lack linguistic characteristics. For example, the training data set 460 may include various types of singing, music, and dialogues. The machine-learning model 425 may be supervised, semi-supervised, or unsupervised to learn whether a pattern of sounds belong to one of the three categories. For example, the training data set 460 may include various samples, such as music, opera, rap music, chorus, conversations, dialogues, speeches, and the like.

The speech component 430 may be identified, defined, and/or detected by determining a ratio of an energy level of the speech component and an overall energy level exceeding a threshold value. In some cases, the speech component extraction module 420 is trained to identify the respective category of the mixed categories of audio content and the threshold value based on a known database of cinematic content (e.g., samples in the training data set 460).

After identifying the speech component 430, the speech component extraction module 420 may be configured to extract the speech component 430 from the original set of audio signals 410. The extracted speech component 430 may undergo speech enhancement via the speech enhancement module 440, as described herein. The speech enhancement module 440 may then output the enhanced speech component 450 to the device 110.

### Example Operations for Source Separation Based Speech Enhancement

Aspects of the present disclosure provide techniques, including devices and system implementing the techniques, for providing source separation based speech enhancement. Providing source separation based speech enhancement may involve extracting a speech component from an input audio stream using a machine learning network, enhancing the extracted speech component, and mixing the enhanced speech component with at least a portion of the input audio stream to generate synchronized playback audio which includes the enhanced speech component.

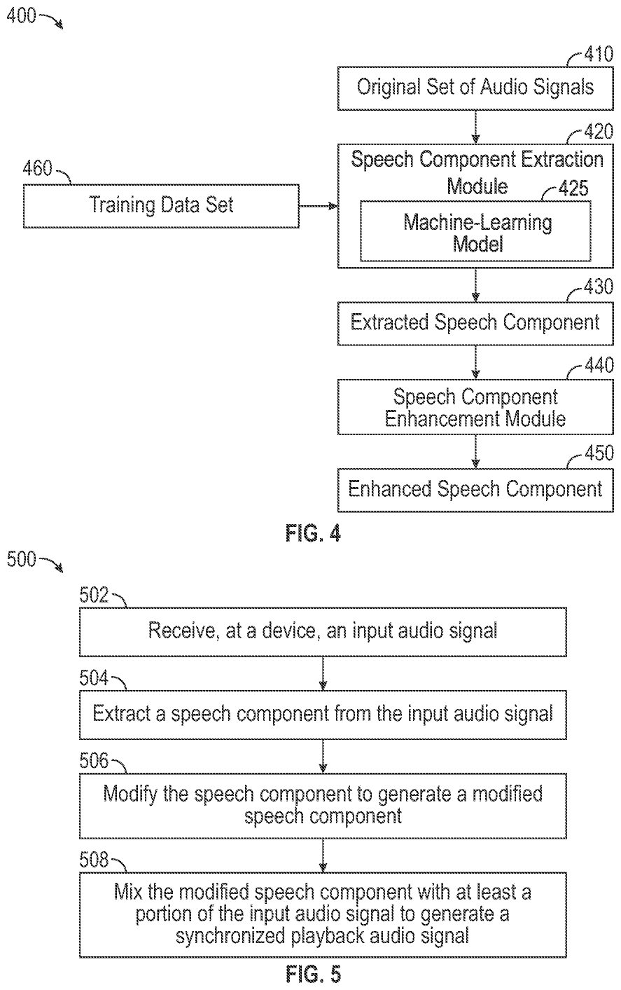

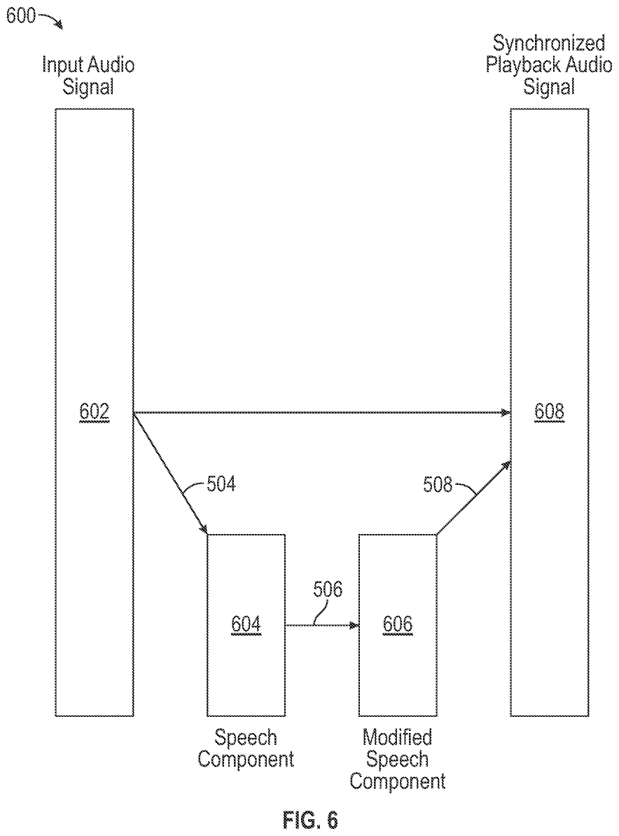

FIG. 5 is a flow diagram illustrating example operations 500 that may be performed by a device 110 (e.g., the audio device or the wearable device of FIGS. 1-3B) for speech enhancement, according to certain aspects of the present disclosure. For example, the example operations 500 may be performed by the device 110 of FIG. 1 or FIG. 2. FIG. 6 illustrates an example input audio signal during the operations of FIG. 5, in accordance with certain aspects of the present disclosure. Therefore, FIG. 5 and FIG. 6 are herein described together for clarity. The operations 500 may allow for the signal-to-noise ratio (SNR) of the speech component 604 of the input audio signal 602 versus the non-speech component of the input audio signal 602 to be increased, without undesirable interference to the speech component 604 from the non-speech portions of the playback audio, and without negative impacts on the non-speech component.

The operations 500 may generally include, at block 502, receiving, at the device 110, an input audio signal. In certain aspects, the device 110 may receive the input audio signal from a source device 120. The device 110 may also receive content data directly from a network 130. In some cases, the input audio stream may be received at the device 110, and the input audio stream may include an input audio signal. In some cases, the received input audio signal may include input audio that accompanies movies, television shows, sporting events, games, music, podcasts, and other similar entertainment. The received input audio signal may include six channel audio (e.g., center, left, right, left surround, right surround, and low frequency effects).

According to certain aspects, the operations 500 may further include, at block 504, extracting a speech component 604 from the input audio signal 602, as illustrated in FIG. 6. In some aspects, extracting the speech component 604 from the input audio signal 602 may involve determining a filter and applying the determined filter to the input audio signal 602 using a fast time scale (e.g., applying an updated filter every 10 milliseconds) to extract the speech component 604. In other aspects, extracting the speech component 606 from the input audio signal 602 may involve predicting which portions of the input audio signal 602 include parts of the speech component 606 and extracting the predicted speech component 604 without using a filter.

In some aspects, extracting the speech component 606 from the input audio signal 602 may be performed using the speech component extraction module 420 (e.g., which may utilize a trained machine-learning model 425), as described above with respect to FIG. 4. In some cases, the speech component extraction module 420 may include or be implemented as a machine-learning network, also as described above with respect to FIG. 4. Metadata associated with the audio input signal 602 may be analyzed, where the metadata includes the speech associated with the speech component 604. The trained machine-learning model may include at least one memory cache configured to store data associated with extracting speech components from input audio signals. The one or more memory caches may be configured to enable the trained machine-learning model to reduce the computation load and/or processing times associated with the operations 500. In some cases, using memory caches may assist in performing redundant calculations. For example, when identifying and extracting the speech component 606, the trained machine-learning model may sequentially process layers of the input audio signal 602, and a lot of the computations during the processing of the layers of the input audio signal 602 may be redundant.

The operations 500 may be capable of being performed almost simultaneously, to allow for only a limited amount of time to elapse from the reception of the audio input signal 602 to the generation of the synchronized playback audio signal 608 that may be output from the device 110. The trained machine-learning model may include a deep learning model configured to predict a filter, the filter being configured to extract the speech component 604 from the input audio signal 602. The filter may be a dynamic filter configured to adapt to the input audio signal 602 to ensure appropriate extraction of the speech component 604 of the input audio signal 602.

In some cases, the input audio signal 602 may not include a speech component. In this case, no speech component is extracted, and the input audio signal 602 may be output by the device 110 unmodified.

According to certain aspects, the operations 500 may further include, at block 506, modifying the extracted speech component 604 to generate a modified speech component 606, as illustrated in FIG. 6. Modifying the speech component 604 to generate the modified speech component 606 may involve a frequency based and/or an energy based modification. In some aspects, modifying the speech component 604 to generate the modified speech component 606 may involve applying a gain to the speech component 604. Applying the gain to the speech component 604 may allow for the SNR ratio of the speech component 604 compared to the non-speech component of the input audio signal 602 to be boosted when the modified speech component 604 is mixed with at least a portion of the input audio signal 602 to generate a synchronized playback audio signal 608, as described in block 508. The gain to that can be applied to the speech component 604 may be determined in a number of ways.

In some aspects, the frequency, energy, and/or the gain used to modify the speech component 604 may be customizable based on at least one of a user input or a user profile. In some cases, a user may choose to increase the gain applied to the speech component 604 to further increase the clarity and intelligibility of the speech component 604. In other cases, a profile associated with a user may be created, and the gain may be based, at least in part, on that user profile. The user profile may be programmed explicitly by the user, may be based on past user activity, may be created using artificial intelligence/machine learning, or any combination thereof. In an example, a user that is hard of hearing may be associated with a certain profile, and the certain profile may cause the speech component 604 to be enhanced significantly to enable the user to more fully enjoy the generated playback audio 608.

In some cases, the gain may be a fixed gain, and a fixed gain may be applied to the speech component 604. For example, a user may always want the speech component 604 to be modified such that the modified speech component 606 is 6 dB higher than the extracted speech component 604.

In some cases, the gain is a dynamic gain associated with a desired SNR of the synchronized playback audio signal 608. For example, a user of the device 110 may want the speech component 604 of the input audio signal 602 to consistently be 6 dB higher than the rest of the input audio signal 602 (e.g., the non-speech component). In some aspects, the input audio signal 602 contains no speech component, and a gain of zero may be applied to the input audio signal 602 (e.g., the input audio signal 602 is not modified). In other aspects, the input audio signal 602 contains a speech component 604, and there is also a lot of music, background noise, and/or action noise in the input audio signal 602. In these aspects, a high gain may be applied to the extracted speech component 604, to ensure that the speech is louder (e.g., 6 dB higher) than the rest of the input audio signal 602.

The desired SNR of the synchronized playback audio signal 608 may be based, at least in part, on a model of an intelligibility of the speech component 604 given the input audio signal 602. The intelligibility model may be a mathematical model that determines how intelligible the speech component 604 of the input audio signal 602 is given the non-speech component of the input audio signal 602.

According to certain aspects, the operations 500 may further include, at block 508, mixing the modified speech component 606 with at least a portion of the input audio signal 602 to generate a synchronized playback audio signal 608. The generated playback audio signal 608 may include the modified speech component 606 and the non-speech component of the input audio signal 602 synchronized in time for cohesive playback on the device 110. In some aspects, mixing the modified speech component 606 with at least a portion of the input audio signal 602 to generate the playback audio signal 608 is based, at least in part, on at least one of a recommendation, a specification, or legislation for an environment that the device 110 is located in, for example European Broadcasting Union (EBU) R 128, Tech 3343, or streaming service requirements.

In some cases, the loudness and/or dynamic range of the speech component 604 relative to the non-speech component of the input audio signal 602 was mixed for an intended listening environment (e.g., commercial theater). Various mixing procedures may also be utilized at block 508 to reprocess the audio to conform to standards and/or recommendations of the actual listening environment (e.g., domestic living room). For example, in a movie theater, mixing the modified speech component 606 with at least a portion of the input audio signal 602 to generate the synchronized playback audio signal 608 may be performed such that the speech of the playback audio signal 608 is quieter and the dynamic range may be larger, because the expectation is that in a movie theater the audio will be played loudly and there will be less background noise. In another example, in a vehicle setting, it is expected that there may be more background noise, so mixing the modified speech component 606 with at least a portion of the input audio signal 602 to generate the synchronized playback audio signal 608 may performed such that the speech of the playback audio signal 608 is louder (e.g., more greatly enhanced) and the dynamic range may be smaller. The intending listening environment may be configurable by the user, or may be known or determined by the device 110.

In some cases, the specification may be based on an intent and desire of the author(s) and/or providers of the audio associated with the input audio signal 602. In these cases, mixing the modified speech component 606 with at least a portion of the input audio signal 602 to generate the synchronized playback audio signal 608 may be performed to be intelligible in the new environment while minimizing the deviation from the specification for the input audio signal, so as to preserve the intent of the author and/or providers of the input audio signal 602.

In some aspects, the modified speech component 606 may be mixed with only a portion of the input audio signal 602 to generate the synchronized playback audio signal 608. For example, the modified speech component 606 may be mixed with the input audio signal 602 minus the extracted speech component 604 to generate the synchronized playback audio signal 608. In other aspects, the modified speech component 606 may be mixed with the entirety of the input audio signal 602 (which includes the original speech component 604) to generate the synchronized playback audio signal 608. For example, the modified speech component 606 may be mixed with the input audio signal 602 which still includes the speech component 604 to generate the synchronized playback audio signal 608.

In some aspects, the operations 500 may be used in a context where a user is using two devices 110 at once to listen to an input audio signal 602. A user may use two devices 110 at once to increase the spatialization (e.g., virtualizing the surround and height channels) of the sound and/or the clarity and intelligibility of speech in audio. In some cases, a user may be using both a wearable device and a sound bar. In these cases, the extracted speech component 604 (e.g., block 504) may be modified by one or both of the wearable device and the sound bar (e.g., block 506) to generate the synchronized playback audio signal 608 (e.g., block 508) at one or both of the wearable device and the sound bar. For example, when the user is using both a wearable device and a sound bar, the user may want the speech component 604 to be enhanced at the wearable device so that the user can hear the speech of the generated playback audio signal 608 unencumbered. In this example, the sound bar may output the input audio signal without performing the operations 500.

In some aspects, the operations 500 may perform block 504 differently, and may not include blocks 506 and 508. In these aspects, after identifying the speech component 604 from the input audio signal 602, the device 110 may determine an EQ which is configured to boost the speech component 604 of the input audio signal 602 to a desired level (e.g., by applying a gain, as described herein) based on the speech component 604. In these aspects, the speech component 604 may not be extracted from the audio input signal 602. The device 110 may then apply the determined EQ to the input audio signal 602 to boost the included speech component 604 in the input audio signal 602 without extracting and modifying the speech component 604 (e.g., block 506) or mixing the extracted speech component 604 into the input audio signal 602 to generate a synchronized playback audio signal 608 (e.g., block 508). In this manner, the device 110 may generate a playback audio signal that includes an enhanced speech component without extracting the speech component 604.

A user may desire to boost certain portions of the speech component 604 more or less than other portions. In some cases, some of the voices in the speech component 604 may be less intelligible than other voices, and the more challenging voices to hear may benefit from being boosted more than other voices. In these cases, modifying different portions of the extracted speech component 604 differently may result in a better generated playback audio for the user. In some aspects, the speech component 604 includes at least a first portion of the speech component and a second portion of the speech component. In these aspects, one of the first portion and second portion of the speech component 604 may be extracted from the extracted speech component 606 (e.g., creating an extracted first portion and an extracted second portion), or the first portion and second portion of the speech component may each remain part of the extracted speech component 604 for previous blocks in the operations 500. Modifying the speech component 604 to generate the modified speech component 606 may include applying a gain to the first portion of the speech component and a different gain to the second portion of the speech component.

It is contemplated that the operations 500 may be continuously performed on an input audio stream to enable the near-simultaneous generation of the playback audio signal 608 with the modified speech component 606 and subsequent output of the generated playback audio signal 608 on the device 110, allowing the user(s) of the device to enjoy the benefits of the speech enhancement throughout the use of the device 110 during entertainment consumption. In some aspects, an EQ may be applied to the generated synchronized playback audio signal 608 by the device 110 after the termination of operations 500 and before the synchronized playback audio signal 608 is output by the device, as dictated by other operations of the device 110.

According to certain aspects, the operations 500 may further include outputting the generated synchronized playback audio signal 608 on the device 110. In some cases, the generated synchronized playback audio signal 608 may include six channel audio (e.g., center, left, right, left surround, right surround, and low frequency effects).

In some embodiments, aspects of the disclosure described herein may be used to identify, extract, and modify other components of the input audio signal 602, as desired to generate the best possible playback audio. In other words, the operations 500 may be applied to various components of the input audio signal 602 to improve the quality of the generated playback audio and/or in response to other factors (e.g., the listening environment). For example, at night, operations (e.g., dynamic range compression, high-pass filtering) 500 may be performed on various components of an input audio signal 602 to soften loud music and background noise (e.g., explosions and/or other action noise), to attempt to prohibit the device used to output the audio from negatively impacting other nearby people.

In some aspects, the modified speech component 606 that was extracted from the input audio signal 602 is mixed back with at least a portion of the input audio signal 602 to achieve dialog clarity enhancement. The extracted speech component 604 of the input audio signal 602 need not be artifact free (e.g., it may include non-speech components of the input audio signal 602), but when the modified speech component 606 is mixed back with the at least a portion of the original input audio signal 602, the latter can mask any artifacts that may have been in the extracted speech component 604 (and that will then likely be in the modified speech component 606), such that the end result is still enjoyable to listen to. In some instances, the remaining portion of the input audio signal 602 from the extracted speech component 604 is also modified in some manner prior to mixing with the modified speech component 606. For instance, the remaining portion of the input audio signal 602 could have the gain, EQ, or some other audio aspect modified.

In some aspects, such as one that includes a soundbar and an open-ear wearable device, the extracted speech component 604 can be sent to the open-ear wearable to enhance dialog clarity and intelligibility for the listener. The extracted or modified speech component 606 plays at the open-ear wearable while the soundbar plays the entirety of the original input audio 602 or the portion that remains after the speech component has been extracted. If multiple people are listening to the audio content (e.g., multiple people watching a movie with the soundbar and their own open-ear wearable), each person could adjust the volume at their own open-ear wearable to increase or decrease the amount of extracted/modified speech content they want to supplement the shared out-loud audio from the soundbar.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. A method for audio signal processing in a device, the method comprising:
receiving, at the device, an input audio signal;
extracting a speech component from the input audio signal;
modifying the speech component to generate a modified speech component; and
mixing the modified speech component with at least a portion of the input audio signal to generate a synchronized playback audio signal.

2. The method of claim 1, wherein the extracting is performed using a trained machine-learning model.

3. The method of claim 2, wherein the trained machine-learning model comprises at least one memory cache configured to store data associated with the extracting.

4. The method of claim 2, wherein the trained machine-learning model comprises a deep learning model configured to predict a filter, the filter being configured to extract the speech component from the input audio signal.

5. The method of claim 1, wherein modifying the speech component to generate the modified speech component comprises:
applying a gain to the speech component.

6. The method of claim 5, wherein the gain is based on at least one of:
a user input; or
a user profile.

7. The method of claim 5, wherein the gain comprises a fixed gain.

8. The method of claim 5, wherein the gain comprises a dynamic gain associated with a desired signal-to-noise ratio (SNR) of the synchronized playback audio signal.

9. The method of claim 8, wherein the desired SNR of the synchronized playback audio signal is based, at least in part, on a model of an intelligibility of the speech component given the input audio signal.

10. The method of claim 5, wherein the mixing is based, at least in part, on at least one of a recommendation, a specification, or legislation for an environment that the device is located in.

11. The method of claim 1, wherein the speech component comprises at least a first portion of the speech component and a second portion of the speech component, wherein modifying the speech component to generate the modified speech component comprises applying a first gain to the first portion of the speech component and a second gain to the second portion of the speech component, and wherein the first gain is different than the second gain.

12. The method of claim 1, wherein the device comprises a wearable audio device.

13. A system, comprising:
a device; and
one or more processors coupled to the device, the one or more processors configured to:
receive, at the device, an input audio signal;
extract a speech component from the input audio signal;
modify the speech component to generate a modified speech component; and
mix the modified speech component with at least a portion of the input audio signal to generate a synchronized playback audio signal.

14. The system of claim 13, wherein the one or more processors are configured to modify the speech component to generate the modified speech component by applying a gain to the speech component.

15. The system of claim 14, wherein the gain comprises a fixed gain.

16. The system of claim 14, wherein the gain comprises a dynamic gain associated with a desired signal-to-noise ratio (SNR) of the synchronized playback audio signal.

17. A non-transitory computer-readable medium comprising computer-executable instructions that, when executed by one or more processors of a device, cause the device to perform a method for audio signal processing, the method comprising:
receiving, at the device, an input audio signal;
extracting a speech component from the input audio signal;
modifying the speech component to generate a modified speech component; and
mixing the modified speech component with at least a portion of the input audio signal to generate a synchronized playback audio signal.

18. The non-transitory computer-readable medium of claim 17, wherein modifying the speech component to generate the modified speech component comprises:
applying a gain to the speech component.

19. The non-transitory computer-readable medium of claim 18, wherein the gain comprises a fixed gain.

20. The non-transitory computer-readable medium of claim 18, wherein the gain comprises a dynamic gain associated with a desired signal-to-noise ratio (SNR) of the synchronized playback audio signal.
